(19) United States
(12) Patent Application Publication
(10) Pub. No.: US 2023/0046304 A1
(43) Pub. Date: Feb. 16, 2023

(54) DISPLAY SYSTEM AND DISPLAY METHOD

(71) Applicant: Nippon Telegraph and Telephone Corporation, Tokyo (JP)

(72) Inventors: Haruka KUBOTA, Musashino-shi, Tokyo (JP); Akira Kataoka, Musashino-shi, Tokyo (JP)

(21) Appl. No.: 17/792,202

(22) PCT Filed: Jan. 24, 2020
(86) PCT No.: PCT/JP2020/002629

§ 371 Date: Jul. 12, 2022

(51) Int. Cl. G06T 7/70; G06T 11/00

(52) U.S. Cl. CPC G06T 7/70; G06T 11/00; G06T 2200/24; G06T 2207/30232

(57) ABSTRACT

A display apparatus (10) of a display system (100) generates a map of a shot region based on video information, and acquires information on a shooting position of each scene in the video information on the map. Then, when receiving specification of a shooting position on the map through a user's operation, the display apparatus (10) searches for information on a scene in the video information shot at the shooting position using the information on the shooting position, and outputs found information on the scene.

### TECHNICAL FIELD

The present invention relates to a display system and a display method.

### BACKGROUND ART

Conventionally, it has been known that video information can accurately reproduce the situation at the time of shooting, and can be utilized in other fields regardless of personal or business use. For example, in performing work such as construction work, moving picture video such as camera video from the worker's point of view can be utilized as work logs for preparing manuals, operation analysis, work trails, and the like.

In such utilization, there are many cases where it is desired to extract only a specific scene from continuous video, but visual work is troublesome and inefficient. Therefore, there has been known a technique for detecting a specific scene by tagging each video scene. For example, in order to extract a specific scene from video, there has been known a method in which a shooting position is detected using a GPS (global positioning system), a stationary sensor, or the like, and a video scene and the shooting position are linked to each other.

### CITATION LIST

### Non-Patent Literature

Non-Patent Literature 1: Sheng Hu, Jianquan Liu, Shoji Nishimura, “High-Speed Analysis and Search of Dynamic Scenes in Massive Videos”, Technical Report of Information Processing Society of Japan, Nov. 11, 2017

### SUMMARY OF THE INVENTION

### Technical Problem

The conventional method has a problem that there are cases where a specific scene cannot be efficiently extracted from video. For example, when a video scene and a shooting position are linked to each other using GPS or the like in order to efficiently extract a specific scene from video, there have been cases where it is difficult to link the shooting position and the video scene to each other indoors or in an environment with many shielding objects. Further, in such an environment, it is conceivable to install a sensor or the like, but the load on the user for installation is heavy.

### Means for Solving the Problem

In order to solve the above-described problems and achieve the object, a display system of the present invention includes: a video processing unit that generates a map of a shot region based on video information, and acquires information on a shooting position of each scene in the video information on the map; and a search processing unit that, when receiving specification of a shooting position on the map through a user's operation, searches for information on a scene in the video information shot at the shooting position using the information on the shooting position, and outputs found information on the scene.

### Effects of the Invention

According to the present invention, an effect is produced that a specific scene can be efficiently extracted from video.

### BRIEF DESCRIPTION OF DRAWINGS

FIG. 1 is a diagram showing an example of a configuration of a display system according to a first embodiment.

FIG. 2 is a diagram illustrating an example of a process of specifying a shooting position on a map to display a corresponding scene.

FIG. 3 is a flowchart showing an example of a processing flow at the time of storing video and parameters in a display apparatus according to the first embodiment.

FIG. 4 is a flowchart showing an example of a processing flow at the time of searching in the display apparatus according to the first embodiment.

FIG. 5 is a diagram showing an example of display of a map including a movement route.

FIG. 6 is a diagram showing an example of display of a map including a movement route.

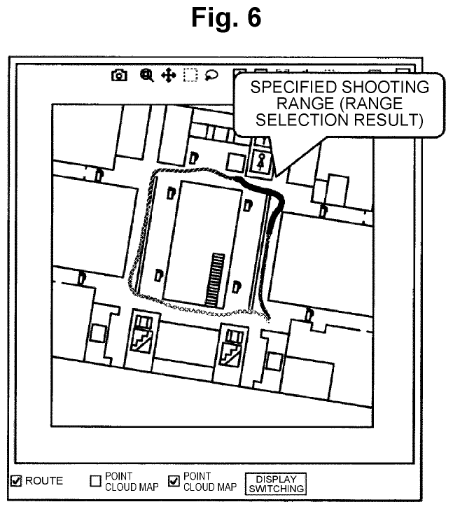

FIG. 7 is a diagram showing an example of a configuration of a display system according to a second embodiment.

FIG. 8 is a flowchart showing an example of a flow of an alignment process in a display apparatus according to the second embodiment.

FIG. 9 is a diagram showing an example of a configuration of a display system according to a third embodiment.

FIG. 10 is a diagram showing an example of operation when a user divides a map into areas in desired units.

FIG. 11 is a diagram illustrating a process of visualizing a staying area of a cameraperson in each scene on a timeline.

FIG. 12 is a flowchart showing an example of a flow of an area division process in a display apparatus according to the third embodiment.

FIG. 13 is a flowchart showing an example of a processing flow at the time of searching in the display apparatus according to the third embodiment.

FIG. 14 is a diagram showing an example of a configuration of a display system according to a fourth embodiment.

FIG. 15 is a diagram illustrating an outline of a process of searching for a scene from the real-time viewpoint.

FIG. 16 is a flowchart showing an example of a processing flow at the time of searching in a display apparatus according to the fourth embodiment.

FIG. 17 is a diagram showing an example of a configuration of a display system according to a fifth embodiment.

FIG. 18 is a diagram illustrating a process of presenting a traveling direction based on a real-time position.

FIG. 19 is a flowchart showing an example of a processing flow at the time of searching in a display apparatus according to the fifth embodiment.

FIG. 20 is a diagram showing a computer that executes a display program.

### DESCRIPTION OF EMBODIMENTS

Hereinafter, embodiments of display systems and display methods according to the present application will be described in detail based on the drawings. Note that the display systems and the display methods according to the present application are not limited by these embodiments.

### First Embodiment

In the following embodiment, a configuration of a display system 100 and a processing flow of a display apparatus 10 according to a first embodiment will be described in order, and effects of the first embodiment will be described finally.

[Configuration of Display System]

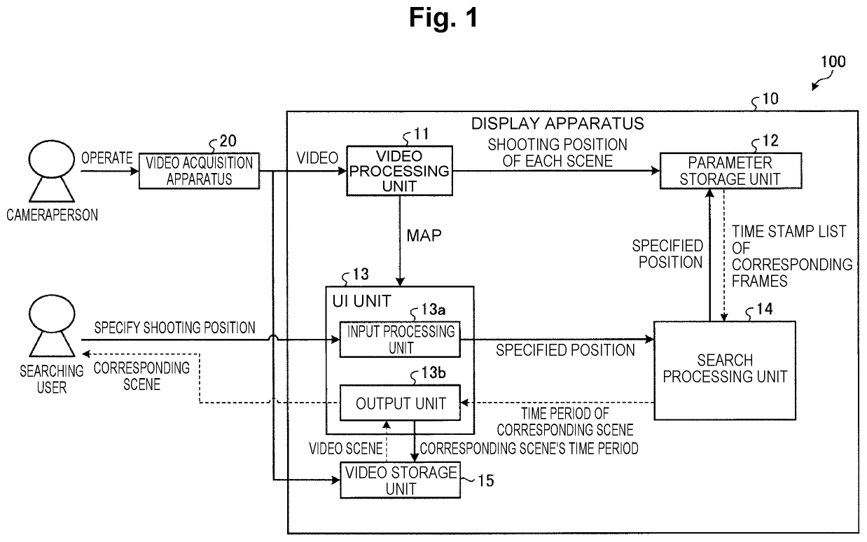

First, a configuration of the display system 100 will be described using FIG. 1. FIG. 1 is a diagram showing an example of a configuration of a display system according to the first embodiment. The display system 100 has the display apparatus 10 and a video acquisition apparatus 20.

The display apparatus 10 is an apparatus that allows an object position or range to be specified on a map including a shooting range shot by the video acquisition apparatus 20, searches video for a video scene including the specified position as a subject, and outputs it. Note that although the example of FIG. 1 is shown assuming that the display apparatus 10 functions as a terminal apparatus, there is no limitation to this, and it may function as a server, or may output a found video scene to a user terminal.

The video acquisition apparatus 20 is equipment such as a camera that shoots video. Note that although the example of FIG. 1 illustrates a case where the display apparatus 10 and the video acquisition apparatus 20 are separate apparatuses, the display apparatus 10 may have the functions of the video acquisition apparatus 20. The video acquisition apparatus 20 notifies a video processing unit 11 of data of video shot by a cameraperson, and stores it in a video storage unit 15.

The display apparatus 10 has the video processing unit 11, a parameter storage unit 12, a UI (user interface) unit 13, a search processing unit 14, and the video storage unit 15. Each unit will be described below. Note that each of the above-mentioned units may be held by a plurality of apparatuses in a distributed manner. For example, the display apparatus 10 may have the video processing unit 11, the parameter storage unit 12, the UI (user interface) unit 13, and the search processing unit 14, and another apparatus may have the video storage unit 15.

Note that the parameter storage unit 12 and the video storage unit 15 are implemented by, for example, a semiconductor memory element such as a RAM (random access memory) or a flash memory, or a storage device such as a hard disk or an optical disc. Further, the video processing unit 11, the parameter storage unit 12, the UI unit 13, and the search processing unit 14 are an electronic circuit such as a CPU (central processing unit) or an MPU (micro processing unit).

The video processing unit 11 generates a map of a shot region based on video information, and acquires information on a shooting position of each scene in the video information on the map.

For example, the video processing unit 11 generates a map from video information using the technique of SLAM (simultaneous localization and mapping), and notifies an input processing unit 13a of information on the map. Further, the video processing unit 11 acquires the shooting position of each scene in the video information on the map, and stores it in the parameter storage unit 12. Note that there is no limitation to the technique of SLAM, and other techniques may be substituted.

Although SLAM is a technique for simultaneously performing self-position estimation and environment map creation, it is assumed in this embodiment that the technique of Visual SLAM is used. In Visual SLAM, pixels or feature points between consecutive frames in video are tracked to estimate the displacement of the self-position using the displacement between the frames. Furthermore, the positions of the pixels or feature points used at that time are mapped as a three-dimensional point cloud to reconstruct an environment map of the shooting environment.

Further, in Visual SLAM, when the self-position has looped, reconstruction of the entire point cloud map (loop closing) is performed so that a previously generated point cloud and a newly mapped point cloud do not conflict with each other. Note that in Visual SLAM, the accuracy, map characteristics, available algorithms, and the like differ depending on the used device, such as a monocular camera, a stereo camera, and an RGB-D camera.

By applying the technique of SLAM and using video and camera parameters (e.g., depth values from an RGB-D camera) as input data, the video processing unit 11 can obtain a point cloud map and pose information of each key frame (a frame time (time stamp), a shooting position (an x coordinate, a y coordinate, and a z coordinate), and a shooting direction (a direction vector or quaternion)) as output data.

The parameter storage unit 12 saves the shooting position in a state where it is linked to each scene of video scenes. The information stored in the parameter storage unit 12 is searched for by the search processing unit 14 described later.

The UI unit 13 has the input processing unit 13a and an output unit 13b. The input processing unit 13a receives specification of a shooting position on the map through an operation performed by a searching user. For example, when the searching user wants to search for a video scene shot from a specific shooting position, the input processing unit 13a receives a click operation for a point at the shooting position on the map through an operation performed by the searching user.

The output unit 13b displays a video scene found by the search processing unit 14 described later. For example, when receiving the time period of a corresponding scene as a search result from the search processing unit 14, the output unit 13b reads the video scene corresponding to the time period of the corresponding scene from the video storage unit 15, and outputs the read video scene. The video storage unit 15 saves video information shot by the video acquisition apparatus 20.

When receiving specification of a shooting position on the map through a user's operation, the search processing unit 14 searches for information on a scene in the video information shot at the shooting position using information on the shooting position, and outputs found information on the scene. For example, when receiving specification of a shooting position on the map through a user's operation via the input processing unit 13a, the search processing unit 14 makes an inquiry to the parameter storage unit 12 about shooting frames taken from the specified shooting position to acquire a time stamp list of the shooting frames, and outputs the time period of a corresponding scene to the output unit 14c.

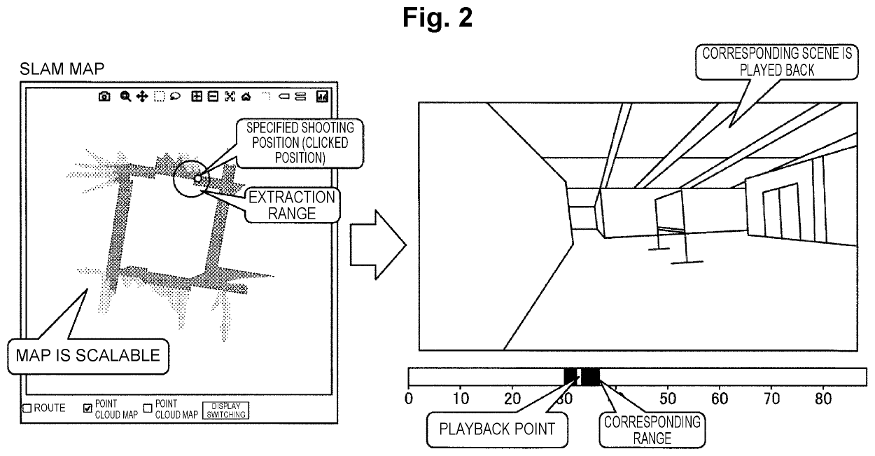

Here, an example of a process of specifying a shooting position on a map to display a corresponding scene will be described using FIG. 2. FIG. 2 is a diagram illustrating an example of a process of specifying a shooting position on a map to display a corresponding scene. As illustrated in FIG. 2, the display apparatus 10 displays a SLAM map on the screen, and when a video position desired to be confirmed is clicked through an operation performed by the searching user, it searches for a corresponding scene shot within a certain distance from the shooting position, and displays the moving picture of the corresponding scene.

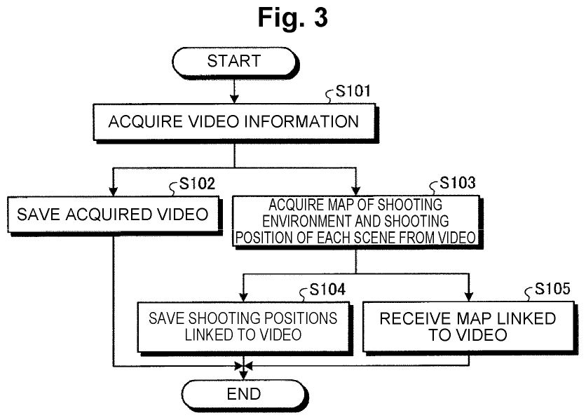

In addition, the display apparatus 10 displays the time period of each found scene in the moving picture, and plots and displays the shooting position of the corresponding scene on the map. Further, as illustrated in FIG. 3, the display apparatus 10 automatically plays back search results in order from the one at the earliest shooting time, and also displays the shooting position and shooting time of the scene being displayed.

[Processing Procedure in Display Apparatus]

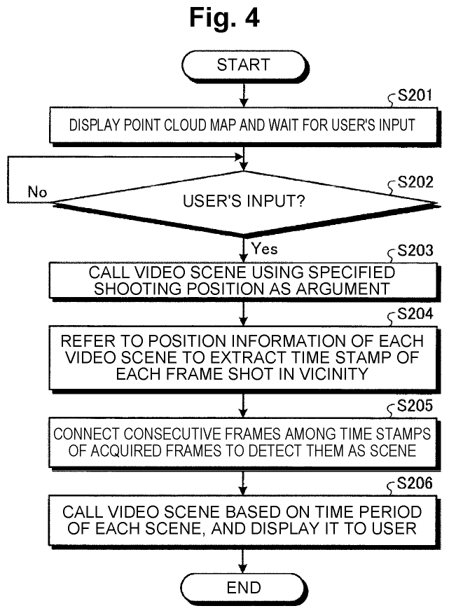

Next, an example of a processing procedure performed by the display apparatus 10 according to the first embodiment will be described using FIGS. 3 and 4. FIG. 3 is a flowchart showing an example of a processing flow at the time of storing video and parameters in the display apparatus according to the first embodiment. FIG. 4 is a flowchart showing an example of a processing flow at the time of searching in the display apparatus according to the first embodiment.

First, a processing flow at the time of storing video and parameters will be described using FIG. 3. As illustrated in FIG. 3, when acquiring video information (step S101), the video processing unit 11 of the display apparatus 10 saves the acquired video in the video storage unit 15 (step S102). Further, the video processing unit 11 acquires a map of the shooting environment and the shooting position of each scene from the video (step S103).

Then, the video processing unit 11 saves the shooting positions linked to the video in the parameter storage unit 12 (step S104). In addition, the input processing unit 13a receives the map linked to the video (step S105).

Next, a processing flow at the time of searching will be described using FIG. 4. As illustrated in FIG. 4, the input processing unit 13a of the display apparatus 10 displays a point cloud map, and waits for the user's input (step S201). Then, when the input processing unit 13a receives the user's input (Yes in step S202), the search processing unit 14 calls a video scene from the parameter storage unit 12 using a shooting position specified by the user's input as an argument (step S203).

The parameter storage unit 12 refers to position information of each video scene to extract the time stamp of each frame shot in the vicinity (step S204). Then, the search processing unit 14 connects consecutive frames among the time stamps of the acquired frames to detect them as a scene (step S205). For example, the search processing unit 14 aggregates consecutive frames with a difference equal to or less than a predetermined threshold among the time stamps of the acquired frames, and acquires the time period of the scene from the first and last frames. Thereafter, the output unit 13b calls a video scene based on the time period of each scene, and presents it to the user (step S206).

[Effects of First Embodiment]

In this way, the display apparatus 10 of the display system 100 according to the first embodiment generates a map of a shot region based on video information, and acquires information on a shooting position of each scene in the video information on the map. Then, when receiving specification of a shooting position on the map through a user's operation, the display apparatus 10 searches for information on a scene in the video information shot at the shooting position using the information on the shooting position, and outputs found information on the scene. Therefore, the display apparatus 10 produces an effect that a specific scene can be efficiently extracted from video.

In addition, by introducing the SLAM function for acquiring the shooting position from within video, the display apparatus 10 can properly grasp the shooting position even in shooting indoors or in a space where there are many shielding objects and GPS information is difficult to use. Furthermore, the display apparatus 10 enables position estimation with higher resolution and fewer blind spots without installing and operating sensors, image markers, or the like in the usage environment, and enables efficient extraction of a specific scene from video.

In addition, by using a function to synchronously acquire the position and an environment map from within video in order to grasp the shooting position of each video scene, the display apparatus 10 can acquire an environment map in which the estimated position is associated with the map without preparing a map of the shooting site or associating a sensor output with the map in advance.

### Second Embodiment

Although the above first embodiment has described a case of displaying the map at the time of searching and receiving the specification of a shooting position from the searching user, it is further possible to visualize the movement trajectory of the cameraperson (shooting position) on the map and receive the specification of a shooting position.

Hereinafter, as a second embodiment, a case will be described where a display apparatus 10A of a display system 100A further displays the movement trajectory of the shooting position on the map, and receives specification of a shooting position from the movement trajectory. Note that the description of the same configuration and processing as in the first embodiment will be omitted as appropriate.

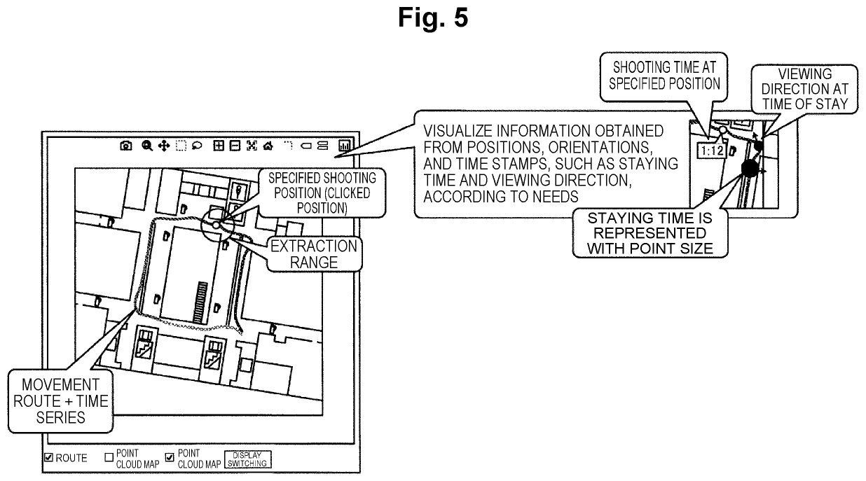

For example, the display apparatus 10A can receive the specification of a shooting position from within the movement trajectory of a specific cameraperson by displaying the route on the map as illustrated in FIG. 5. In addition, the display apparatus 10 may visualize information obtained from positions, orientations, and time stamps, such as a staying time and a viewing direction, according to the needs. Further, the display apparatus 10 may receive the specification of a shooting range from within the movement trajectory. In this way, the display apparatus 10 displays the route on the map, and this is effective when the searching user figures out what a certain cameraperson has done in each place, and can facilitate the utilization of video.

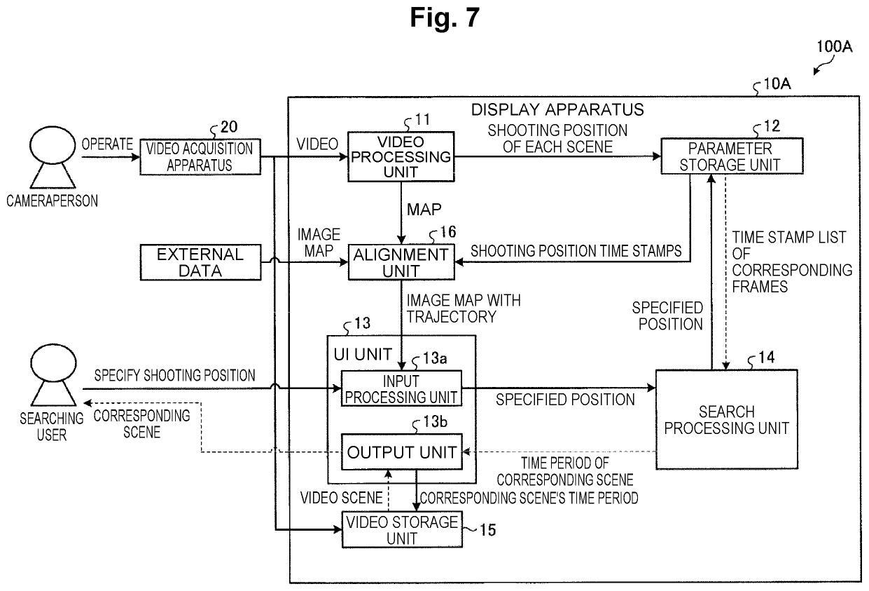

FIG. 7 is a diagram showing an example of a configuration of the display system according to the second embodiment. The display apparatus 10A is different from the display apparatus 10 according to the first embodiment in that it has an alignment unit 16.

The alignment unit 16 deforms an image map acquired from outside so that positions correspond to each other between the image map and the map generated by the video processing unit 11, plots the shooting position on the image map in chronological order, and generates a map including a movement trajectory obtained by connecting consecutive plots with a line.

The input processing unit 13a further displays the movement trajectory of the shooting position on the map, and receives the specification of a shooting position from the movement trajectory. That is, the input processing unit 13a displays the map including the movement trajectory generated by the alignment unit 16, and receives specification of a shooting position from the movement trajectory.

In this way, the display apparatus 10A can map the shooting positions onto the image map based on the positional correspondence between the point cloud map and the image map, and connect them in chronological order to visualize the movement trajectory.

Further, the input processing unit 13a extracts a parameter in shooting from the video information, displays information obtained from the parameter in shooting, displays the map generated by the video processing unit 11, and receives specification of a shooting position on the displayed map. That is, as illustrated in FIG. 5, the input processing unit 13a may extract, for example, the positions, orientations, and time stamps of each video scene from within the video as parameters in shooting, and display the shooting time at a specified position and the viewing direction at the time of stay on the map based on the positions, orientations, and time stamps, or represent the length of the staying time with the point size.

[Processing Procedure in Display Apparatus]

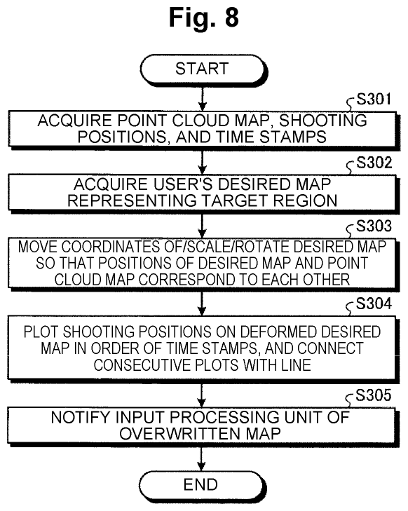

Next, an example of a processing procedure by the display apparatus 10A according to the second embodiment will be described using FIG. 8. FIG. 8 is a flowchart showing an example of a flow of an alignment process in a display apparatus according to the second embodiment.

As illustrated in FIG. 8, the alignment unit 16 of the display apparatus 10A acquires the point cloud map, shooting positions, and time stamps (step S301), and acquires the user's desired map representing a target region (step S302).

Then, the alignment unit 16 moves the coordinates of/scales/rotates the desired map so that the positions of the desired map and the point cloud map correspond to each other (step S303). Subsequently, the alignment unit 16 plots shooting positions on the deformed desired map in the order of time stamps, and connects consecutive plots with a line (step S304). Then, the alignment unit 16 notifies the input processing unit of the overwritten map (step S305).

[Effects of Second Embodiment]

In this way, in the display system 100A according to the second embodiment, the display apparatus 10A visualizes the movement trajectory on the map, thereby producing an effect that the user can specify a shooting position that they want to confirm after confirming the movement trajectory. That is, it is possible for the searching user to search video after grasping the outline of the behavior of a specific worker.

### Third Embodiment

The display apparatus of the display system may be configured to allow the user to divide the map into areas in desired units, and configured to visualize the staying block on the timeline based on the shooting position of each scene to allow the user to specify a time period that they want to search for while confirming the transition of the staying block. Therefore, as a third embodiment, a case will be described where a display apparatus 10B of a display system 100B receives an instruction to segment the region on the map into desired areas, divides the region on the map into areas based on the instruction, displays the map divided into areas at the time of searching, and receives specification of a shooting position on the displayed map. Note that the description of the same configuration and processing as in the first embodiment will be omitted as appropriate.

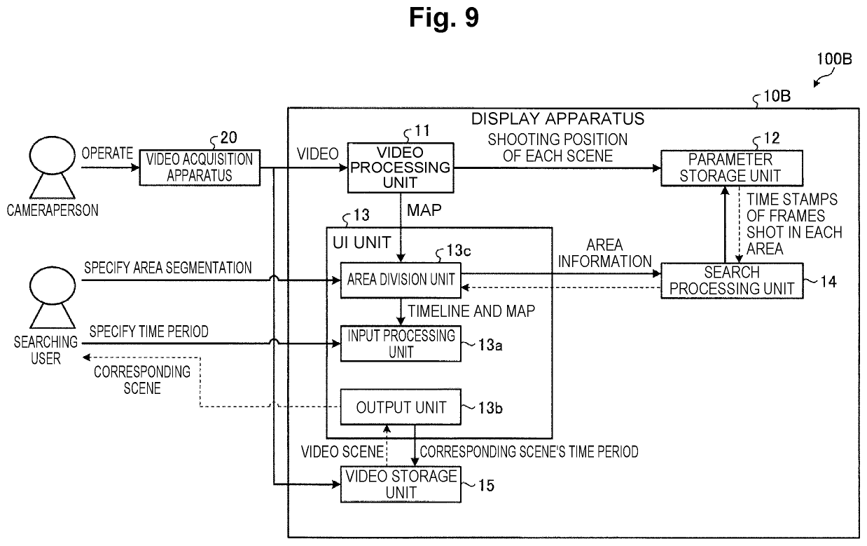

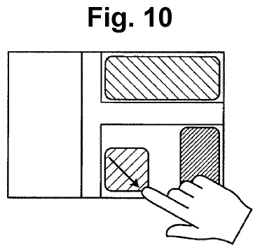

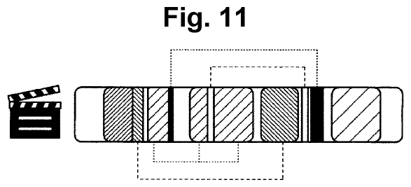

FIG. 9 is a diagram showing an example of a configuration of a display system according to the third embodiment. As illustrated in FIG. 9, the display apparatus 10B is different from the first embodiment in that it has an area division unit 13c. The area division unit 13c receives an instruction to segment the region on the map into desired areas, and divides the region on the map into areas based on the instruction. For example, as illustrated in FIG. 10, the area division unit 13c segments the region on the map into desired areas through the user's operation, and colors each of the segmented areas. Further, for example, together with the map divided into areas, the area division unit 13c color-codes the timeline so that the staying block of the cameraperson in each scene can be seen, as illustrated in FIG. 11.

The input processing unit 13a displays the map divided into areas by the area division unit 13c, and receives specification of a time period corresponding to an area in the displayed map. For example, the input processing unit 13a acquires and displays the map that has been divided into areas and the timeline from the area division unit 13c, and receives specification of one or more desired time periods on the timeline from the searching user.

[Processing Procedure in Display Apparatus]

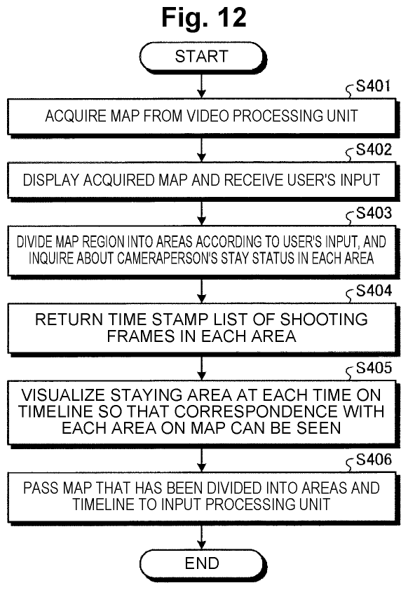

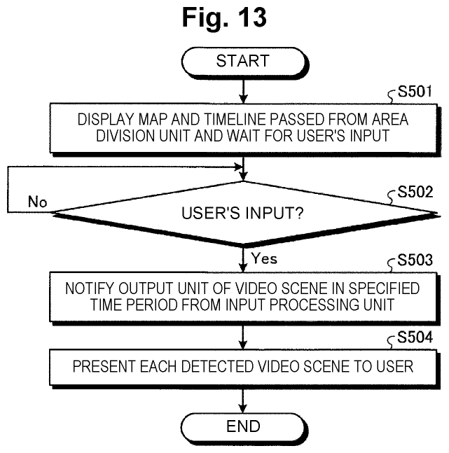

Next, an example of a processing procedure by the display apparatus 10B according to the third embodiment will be described using FIGS. 12 and 13. FIG. 12 is a flowchart showing an example of a flow of an area division process in a display apparatus according to the third embodiment. FIG. 13 is a flowchart showing an example of a processing flow at the time of searching in the display apparatus according to the third embodiment.

First, a flow of an area division process will be described using FIG. 12. As illustrated in FIG. 12, the area division unit 13c of the display apparatus 10 acquires a map from the video processing unit 11 (step S401). Then, the area division unit 13c displays the acquired map and receives an input from the user (step S402).

Then, the area division unit 13c divides it into areas according to the input from the user, and inquires of the parameter storage unit 12 about the cameraperson's stay status in each area (step S403). Then, the parameter storage unit 12 returns a time stamp list of shooting frames in each area to the area division unit 13c (step S404).

The area division unit 13c visualizes the staying area at each time on the timeline so that correspondence with each area on the map can be seen (step S405). Then, the area division unit 13c passes the map that has been divided into areas and the timeline to the input processing unit 13a (step S406).

Next, a processing flow at the time of searching will be described using FIG. 13. As illustrated in FIG. 13, the input processing unit 13a of the display apparatus 10 displays the map and the timeline passed from the area division unit 13c, and waits for the user's input (step S501).

Then, when the input processing unit 13a receives the user's input (Yes in step S502), the search processing unit 14 calls a video scene in the time period specified by the user's input from the parameter storage unit 12, and notifies it to the output unit 1b (step S503). Thereafter, the output unit 13b calls a video scene based on the time period of each scene, and presents it to the user (step S504).

[Effects of Third Embodiment]

In this way, in the display system 100B according to the third embodiment, the user performs division into desired areas on the map, and the display apparatus 10B displays the timeline showing the shooting time period in each area together with the map divided into areas, so the searching user can easily search for video by selecting a time period from the timeline. Therefore, the display system 100B is particularly effective in the case of identifying work that is performed while going back and forth between a plurality of places, or when the user wants to confirm the staying time in each block. In addition, for example, the display system 100B is also effective for referring to a block with a significantly different staying time in a plurality of videos in which the same work is shot, cutting out video scenes in two specific blocks between which work is performed while going back and forth, selecting rooms through blocking in units of rooms to remove videos while moving in a corridor or the like, etc.

### Fourth Embodiment

Although the above first embodiment has described a case where the searching user specifies a shooting position at the time of searching to search for a video scene at the specified shooting position, there is no limitation to such a case, and, for example, it is also possible to allow the searching user to shoot video in real time to search for a video scene at the same shooting position.

In the following, as a fourth embodiment, a case will be described where a display apparatus 10C of a display system 100C acquires real-time video information shot by a user, generates a map of a shot region, identifies a shooting position of the user on the map from the video information, and searches for information on a scene at the same or a similar shooting position using the identified shooting position of the user. Note that the description of the same configuration and processing as in the first embodiment will be omitted as appropriate.

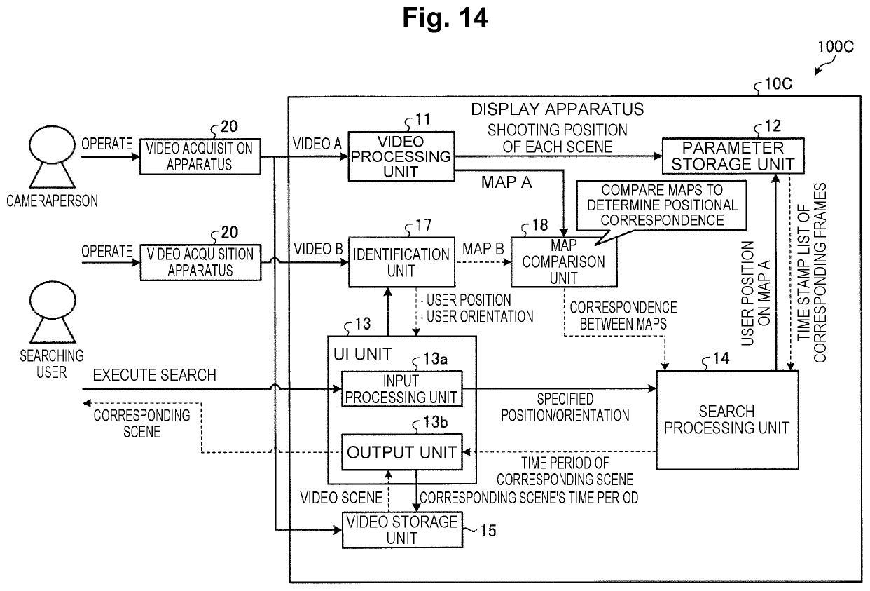

FIG. 14 is a diagram showing an example of a configuration of a display system according to the fourth embodiment. As illustrated in FIG. 14, the display apparatus 10C of the display system 100C is different from the first embodiment in that it has an identification unit 17 and a map comparison unit 18.

The identification unit 17 acquires real-time video information shot by the searching user from the video acquisition apparatus 20 such as a wearable camera, generates a map B of a shot region based on the video information, and identifies the shooting position of the user on the map from the video information. Then, the identification unit 17 notifies the map comparison unit 18 of the generated map B, and notifies the search processing unit 14 of the identified shooting position of the user. Note that the identification unit 17 may also identify the orientation together with the shooting position.

For example, the identification unit 17 may generate a map from the video information by tracking feature points using the technique of SLAM, and acquires the shooting position and shooting direction of each scene, as in the video processing unit 11.

The map comparison unit 18 compares a map A received from the video processing unit 11 with the map B received from the identification unit 17, determines the correspondence between the two, and notifies the search processing unit 14 of the correspondence between the maps.

The search processing unit 14 searches for information on a scene at the same or a similar shooting position from among the scenes stored in the parameter storage unit 12 using the shooting position and shooting direction of the user identified by the identification unit 17, and outputs found information on the scene. For example, the search processing unit 14 inquires about a video scene based on the shooting position and shooting direction of the searching user on the map A of a predecessor, acquires a time stamp list of shooting frames, and outputs the time period of a corresponding scene to the output unit 13b.

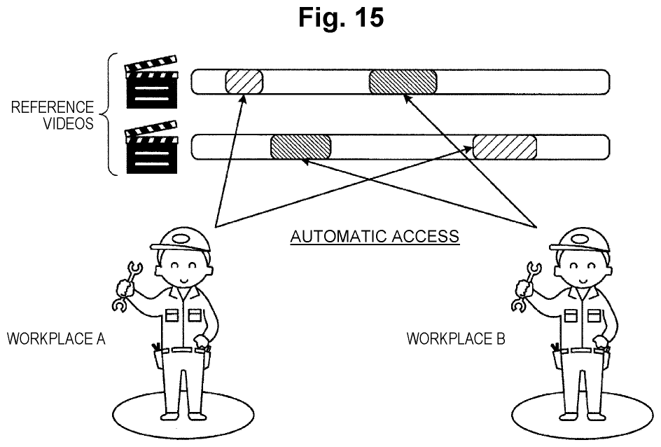

As a result, in the display apparatus 10C, the searching user can shoot viewpoint video up to a search point, and receive a video scene shot at the current position based on the comparison between the obtained map B and the stored map A. Here, an outline of a process of searching for a scene from the real-time viewpoint will be described using FIG. 15. FIG. 15 is a diagram illustrating an outline of a process of searching for a scene from the real-time viewpoint.

For example, when a user wants to view a past work history related to a workplace A, the user wearing a wearable camera moves to the workplace A, shoots video of the workplace A with the wearable camera, and instructs the display apparatus 10C to execute a search. The display apparatus 10C searches for a scene in the past work history in the workplace A, and displays video of the scene.

[Processing Procedure in Display apparatus]

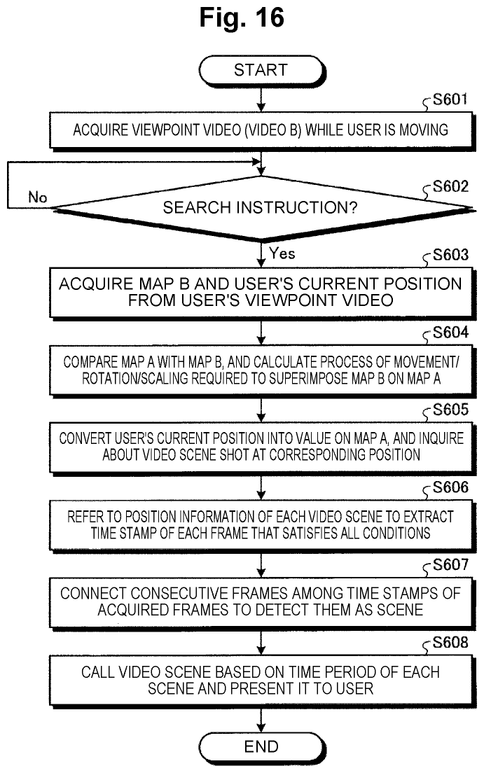

Next, an example of a processing procedure by the display apparatus 10C according to the fourth embodiment will be described using FIG. 16. FIG. 16 is a flowchart showing an example of a processing flow at the time of searching in a display apparatus according to the fourth embodiment.

As illustrated in FIG. 16, the identification unit 17 of the display apparatus 10C acquires viewpoint video while the user is moving (corresponding to video B in FIG. 14) (step S601). Thereafter, the identification unit 17 determines whether a search instruction from the user has been received (step S602). Then, when receiving a search instruction from the user (Yes in step S602), the identification unit 17 acquires the map B and the user's current position from the user's viewpoint video (step S603).

Then, the map comparison unit 18 compares the map A with the map B, and calculates a process of movement/rotation/scaling required to superimpose the map B on the map A (step S604). Subsequently, the search processing unit 14 converts the user's current position into a value on the map A, and inquires about a video scene shot at the corresponding position (step S605).

The parameter storage unit 12 refers to position information of each video scene to extract the time stamp of each frame that satisfies all the conditions (step S606). Then, the search processing unit 14 connects consecutive frames among the time stamps of the acquired frames to detect them as a scene (step S607). Thereafter, the output unit 13b calls a video scene based on the time period of each scene, and presents it to the user (step S608).

[Effects of Fourth Embodiment]

As described above, in the display system 100C according to the fourth embodiment, the display apparatus 10C acquires real-time video information shot by a user, generates a map of a shot region based on the video information, and identifies the shooting position of the user on the map from the video information. Then, the display apparatus 10C searches for information on a scene at the same or a similar shooting position from among the scenes stored in the parameter storage unit 12 using the identified shooting position of the user, and outputs found information on the scene. Therefore, the display apparatus 10C makes it possible to search for a scene shot at the current position from video obtained in real time, for example, it is possible to view a past work history related to the workplace at the current position in real time using the self-position as a search key.

### Fifth Embodiment

Although the above fifth embodiment has described a case of acquiring real-time video shot by the searching user and searching for a scene shot at the current position using the self-position as a search key, there is no limitation to this, for example, it is possible to acquire real-time video shot by the searching user and output the traveling direction for reproducing a video scene and actions at the same stage using the self-position as a search key.

In the following, as a fifth embodiment, a case will be described in which a display apparatus 10D of a display system 100D acquires real-time video shot by the searching user and outputs the traveling direction for reproducing a video scene and actions at the same stage using the self-position as a search key. Note that the description of the same configuration and processing as in the first embodiment and the fourth embodiment will be omitted as appropriate.

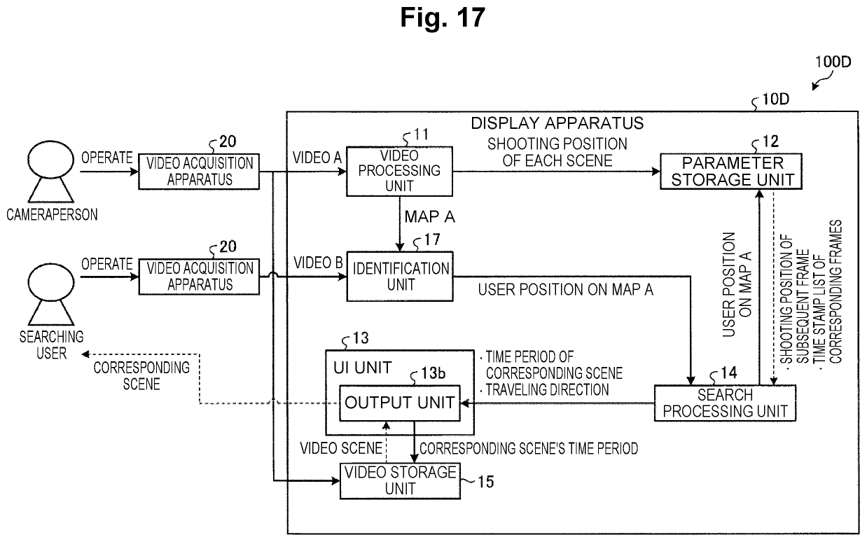

FIG. 17 is a diagram showing an example of a configuration of a display system according to the fifth embodiment. As illustrated in FIG. 17, the display apparatus 10D of the display system 100D is different from the first embodiment in that it has the identification unit 17.

The identification unit 17 acquires real-time video information shot by the searching user from the video acquisition apparatus 20 such as a wearable camera, generates a map of a shot region based on the video information, and identifies the shooting position of the user on the map from the video information. Note that the identification unit 17 may also identify the orientation together with the shooting position. For example, the identification unit 17 may generate a map from the video information by tracking feature points using the technique of SLAM, and acquires the shooting position and shooting direction of each scene, as in the video processing unit 11.

The search processing unit 14 searches for information on a scene at the same or a similar shooting position from the scenes stored in the parameter storage unit 12 using the shooting position of the user identified by the identification unit 17, determines the traveling direction of the cameraperson of the video information from the shooting position of a subsequent frame in the scene, and further outputs the traveling direction.

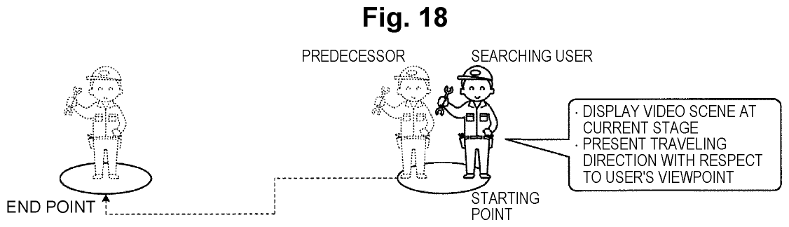

Here, a process of presenting a traveling direction based on a real-time position will be described using FIG. 18. FIG. 18 is a diagram illustrating a process of presenting a traveling direction based on a real-time position.

For example, as illustrated in FIG. 18, at the starting point, the display apparatus 10D displays a video scene at the current stage to the searching user, and the user starts shooting viewpoint video at the starting point of a reference video. Then, the display apparatus 10D acquires video in real time, estimates the position on the map, and presents a video scene shot at the user's current position and the shooting direction.

In addition, the display apparatus 10D retries the position estimation as the user moves, and updates the output of the video scene and the shooting direction. Thereby, as illustrated in FIG. 18, the display apparatus 10 can perform navigation so that the searching user can follow the same route as a predecessor to reach the end point from the start point.

[Processing Procedure in Display Apparatus]

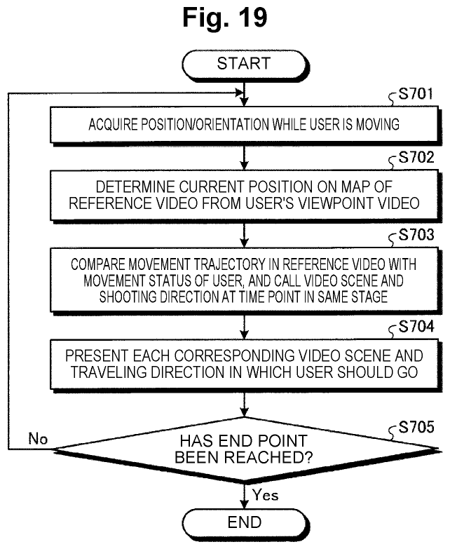

Next, an example of a processing procedure by the display apparatus 10D according to the fifth embodiment will be described using FIG. 19. FIG. 19 is a flowchart showing an example of a processing flow at the time of searching in a display apparatus according to the fifth embodiment.

As illustrated in FIG. 19, the identification unit 17 of the display apparatus 10D acquires viewpoint video and the position/orientation while the user is moving (step S701). Thereafter, the identification unit 17 determines the current position on the map of the reference video from the viewpoint video (step S702). Note that it is assumed here that the shooting start point of the reference video is the same as the shooting start point of the viewpoint video.

Then, the search processing unit 14 compares the movement trajectory in the reference video with the movement status of the user, and calls a video scene and a shooting direction at a time point in the same stage (step S703). Then, the output unit 13b presents each corresponding video scene and the traveling direction in which the user should go (step S704). Thereafter, the display apparatus 10D determines whether or not the end point has been reached (step S705), and when the end point has not been reached (No in step S705), it returns to the process of S701, and repeats the above processes. When the end point has been reached (Yes in step S705), the display apparatus 10D ends the process of this flow.

[Effects of Fifth Embodiment]

In this way, in the display system 100D according to the fifth embodiment, the display apparatus 10D acquires real-time video shot by the searching user and outputs the traveling direction for reproducing a video scene and actions at the same stage using the self-position as a search key. Therefore, the display apparatus 10D can perform navigation so that the searching user can follow the same route as a predecessor to reach the end point from the start point.

[System Configuration, etc.]

Further, each component of each apparatus shown in the figures is functionally conceptual, and does not necessarily have to be physically configured as shown in the figures. That is, the specific form of distribution/integration of each apparatus is not limited to those shown in the figures, and the whole or part thereof can be configured in a functionally or physically distributed/integrated manner in desired units according to various loads or usage conditions. Further, for each processing function performed in each apparatus, the whole or any part thereof may be implemented by a CPU and a program analyzed and executed by the CPU, or may be implemented as hardware by wired logic.

Further, among the processes described in the embodiments, all or part of the processes described as being performed automatically can be performed manually, or all or part of the processes described as being performed manually can be performed automatically using a known method. In addition, the processing procedures, control procedures, specific names, and information including various types of data and parameters described in the above document and shown in the drawings can be optionally modified unless otherwise specified.

[Program]

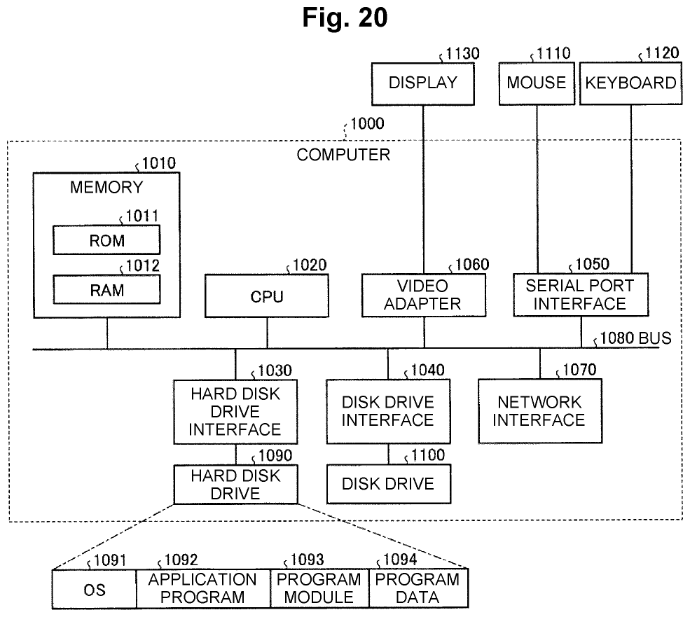

FIG. 20 is a diagram showing a computer that executes a display program. The computer 1000 has, for example, a memory 1010 and a CPU 1020. The computer 1000 also has a hard disk drive interface 1030, a disk drive interface 1040, a serial port interface 1050, a video adapter 1060, and a network interface 1070. These parts are connected to each other via a bus 1080.

The memory 1010 includes a ROM (read only memory) 1011 and a RAM 1012. The ROM 1011 stores, for example, a boot program such as a BIOS (basic input output system). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1051 and a keyboard 1052. The video adapter 1060 is connected to, for example, a display 1061.

The hard disk drive 1090 stores, for example, an OS 1091, an application program 1092, a program module 1093, and program data 1094. That is, a program that defines each process in the display apparatus is implemented as the program module 1093 in which a code executable by the computer is written. The program module 1093 is stored in, for example, the hard disk drive 1090. For example, the program module 1093 for executing the same processing as the functional configuration in the apparatus is stored in the hard disk drive 1090. Note that the hard disk drive 1090 may be replaced by an SSD (solid state drive).

Further, data used in the processing of the above-described embodiments is stored in, for example, the memory 1010 and the hard disk drive 1090 as the program data 1094. Then, the CPU 1020 reads and executes the program module 1093 and the program data 1094 stored in the memory 1010 and the hard disk drive 1090 onto the RAM 1012 as necessary.

Note that the program module 1093 and the program data 1094 are not limited to cases where they are stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network or WAN. Then, the program module 1093 and the program data 1094 may be read by the CPU 1020 from the other computer via the network interface 1070.

### REFERENCE SIGNS LIST

10, 10A, 10B, 10C, 10D Display apparatus

11 Video processing unit

12 Parameter storage unit

13 UI unit

13a Input processing unit

13b Output unit

14 Search processing unit

15 Video storage unit

16 Alignment unit

17 Identification unit

18 Map comparison unit

20 Video acquisition apparatus

100, 100A, 100B, 100C, 100D Display system

1. A display system comprising:
a video processing unit, including one or more processors, configured to generate a map of a shot region based on video information, and acquires information on a shooting position of each scene in the video information on the map; and
a search processing unit, including one or more processors, that is configured to, when receiving specification of a shooting position on the map through a user's operation, search for information on a scene in the video information shot at the shooting position using the information on the shooting position, and output found information on the scene.

2. The display system according to claim 1, further comprising an input processing unit, including one or more processors, configured to extract a parameter in shooting from the video information, display information obtained from the parameter in shooting, display the map generated by the video processing unit, and receive specification of a shooting position on the displayed map.

3. The display system according to claim 2, wherein the input processing unit is further configured to display a movement trajectory of a shooting position on the map, and receive specification of a shooting position from the movement trajectory.

4. The display system according to claim 2, further comprising
an area division unit, including one or more processors, configured to receive that an instruction to segment a region on the map into desired areas, and divide divides the region on the map into areas based on the instruction,
wherein the input processing unit is configured to display the map divided into areas by the area division unit, and receive specification of a time period corresponding to an area in the displayed map.

5. The display system according to claim 1, further comprising
an identification unit, including one or more processors, configured to acquire real-time video information shot by a user, generate a map of a shot region based on the video information, and identify a shooting position of the user on the map from the video information,
wherein the search processing unit is configured to search for information on a scene at a same or similar shooting position from among scenes using the shooting position of the user identified by the identification unit, and output outputs found information on the scene.

6. The display system according to claim 5, wherein:
the identification unit is configured to identify the shooting position of the user on the map generated by the video processing unit; and
the search processing unit is configured to search for information on a scene at a same or similar shooting position from among the scenes using the shooting position of the user identified by the identification unit, determine a traveling direction of a cameraperson of the video information from a shooting position of a subsequent frame in the scene, and further output the traveling direction.

7. The display system according to claim 3, further comprising
an alignment unit, including one or more processors, configured to deform an image map acquired from outside so that positions correspond to each other between the image map and the map generated by the video processing unit, plot the shooting position on the image map in chronological order, and generate a map including a movement trajectory obtained by connecting consecutive plots with a line; and
wherein the input processing unit is configured to display the map including the movement trajectory generated by the alignment unit, and receive specification of a shooting position from the movement trajectory.

8. A display method executed by a display system, the display method comprising:
generating a map of a shot region based on video information, and acquiring information on a shooting position of each scene in the video information on the map; and
when receiving specification of a shooting position on the map through a user's operation, searching for information on a scene in the video information shot at the shooting position using the information on the shooting position, and outputting found information on the scene.

9. The display method according to claim 8, further comprising:
extracting a parameter in shooting from the video information, display information obtained from the parameter in shooting;
displaying the generated map; and
receiving specification of a shooting position on the displayed map.

10. The display method according to claim 9, further comprising:
displaying a movement trajectory of a shooting position on the map; and
receiving specification of a shooting position from the movement trajectory.

11. The display method according to claim 10, further comprising:
deforming an image map acquired from outside so that positions correspond to each other between the image map and the generated map;
plotting the shooting position on the image map in chronological order;
generating a map including a movement trajectory obtained by connecting consecutive plots with a line;
displaying the map including the movement trajectory; and
receiving specification of a shooting position from the movement trajectory.

12. The display method according to claim 9, further comprising:
receiving that an instruction to segment a region on the map into desired areas;
dividing the region on the map into areas based on the instruction;
displaying the map divided into areas; and
receiving specification of a time period corresponding to an area in the displayed map.

13. The display method according to claim 8, further comprising:
acquiring real-time video information shot by a user;
generating a map of a shot region based on the video information;
identifying a shooting position of the user on the map from the video information;
searching for information on a scene at a same or similar shooting position from among scenes using the shooting position of the user; and
outputting found information on the scene.

14. The display method according to claim 13, comprising:
identifying the shooting position of the user on the generated map;
searching for information on a scene at a same or similar shooting position from among the scenes using the shooting position of the user;
determining a traveling direction of a cameraperson of the video information from a shooting position of a subsequent frame in the scene; and
outputting the traveling direction.

15. A non-transitory computer readable medium storing one or more instructions causing a computer to execute:
generating a map of a shot region based on video information, and acquiring information on a shooting position of each scene in the video information on the map; and
when receiving specification of a shooting position on the map through a user's operation, searching for information on a scene in the video information shot at the shooting position using the information on the shooting position, and outputting found information on the scene.

16. The non-transitory computer readable medium according to claim 15, wherein the one or more instructions cause the computer to execute:
extracting a parameter in shooting from the video information, display information obtained from the parameter in shooting;
displaying the generated map; and
receiving specification of a shooting position on the displayed map.

17. The non-transitory computer readable medium according to claim 16, wherein the one or more instructions cause the computer to execute:
displaying a movement trajectory of a shooting position on the map; and
receiving specification of a shooting position from the movement trajectory.

18. The non-transitory computer readable medium according to claim 17, wherein the one or more instructions further cause the computer to execute:
deforming an image map acquired from outside so that positions correspond to each other between the image map and the generated map;
plotting the shooting position on the image map in chronological order;
generating a map including a movement trajectory obtained by connecting consecutive plots with a line;
displaying the map including the movement trajectory; and
receiving specification of a shooting position from the movement trajectory.

19. The non-transitory computer readable medium according to claim 16, wherein the one or more instructions further cause the computer to execute:
receiving that an instruction to segment a region on the map into desired areas;
dividing the region on the map into areas based on the instruction;
displaying the map divided into areas; and
receiving specification of a time period corresponding to an area in the displayed map.

20. The non-transitory computer readable medium according to claim 15, wherein the one or more instructions further cause the computer to execute:
acquiring real-time video information shot by a user;
generating a map of a shot region based on the video information;
identifying a shooting position of the user on the map from the video information;
searching for information on a scene at a same or similar shooting position from among scenes using the shooting position of the user; and
outputting found information on the scene.
